(19) United States
(12) Patent Application Publication
(10) Pub. No.: US 2013/0296520 A1
(43) Pub. Date: Nov. 7, 2013

(54) MEDIUM VOLTAGE CABLE JACKETING

(71) Applicant: Equistar Chemicals, LP, Houston, TX (US)

(72) Inventor: CINDY L. FLENNIKEN, Clarksville, OH (US)

(21) Appl. No.: 13/850,926

(22) Filed: Mar. 26, 2013

Related U.S. Application Data
(60) Provisional application No. 61/615,626, filed on Mar. 26, 2012.

(51) Int. Cl. C08F 110/06

(52) U.S. Cl. CPC C08F 110/06
USPC 526/351

(57) ABSTRACT

In the most preferred embodiments, the polypropylene jackets will meet the following specifications: a tensile strength of greater than or equal to 1500 psi (or greater than or equal to 10.3 MPa); and elongation at break of 150% or greater. Additionally, the aged requirements (121° C. for 168 hours) in most preferred embodiments are a retained tensile strength that is 70% of the original, and a retained elongation that is 70% of the original. Additionally, in most 10 preferred embodiments, the heat distortion at 131° C. is less than or equal to 30%. Additionally, in most preferred embodiments then carbon black percentage is 2% or greater. It should be understood, that in other embodiments of the polypropylene jackets, the various specifications and or requirements may fall outside some or all of these ranges.

### BACKGROUND

The present invention relates to the use of polypropylene jackets with cross-linked polyethylene (XLPE) insulated medium voltage cables.

Linear low density polyethylene has been the primary jacketing resin for medium voltage XLPE insulated cables in the North American region in recent times. In other regions, such as in Europe, the focus has largely been on 10 medium density polyethylene and high density polyethylene jacketing for medium voltage applications. It is believed that polypropylene based jacketing is a viable option for use in cross-linked polyethylene medium voltage cables.

### SUMMARY OF THE INVENTION

The present invention relates to the use of polypropylene in jacketing for medium voltage cables.

In some embodiments, the polypropylene jackets will 5 meet the following specifications: a tensile strength of greater than or equal to 1500 psi (or greater than or equal to 10.3 MPa); and elongation at break of 150% or greater. Additionally, the aged requirements (121° C. for 168 hours) in most preferred embodiments are a retained tensile strength that is 70% of the original, and a retained elongation that is 70% of the original. Additionally, in most 10 preferred embodiments, the heat distortion at 131° C. is less than or equal to 30%. Additionally, in most preferred embodiments then carbon black percentage is 2% or greater. It should be understood, that in other embodiments of the polypropylene jackets, the various specifications and or requirements may fall outside some or all of these ranges.

The features and advantages of the present invention will be readily apparent to those skilled in the art upon a reading of the description of the preferred embodiments that follows.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 shows the resin physical properties;

FIG. 2 shows the crush on wire (no black master batch);

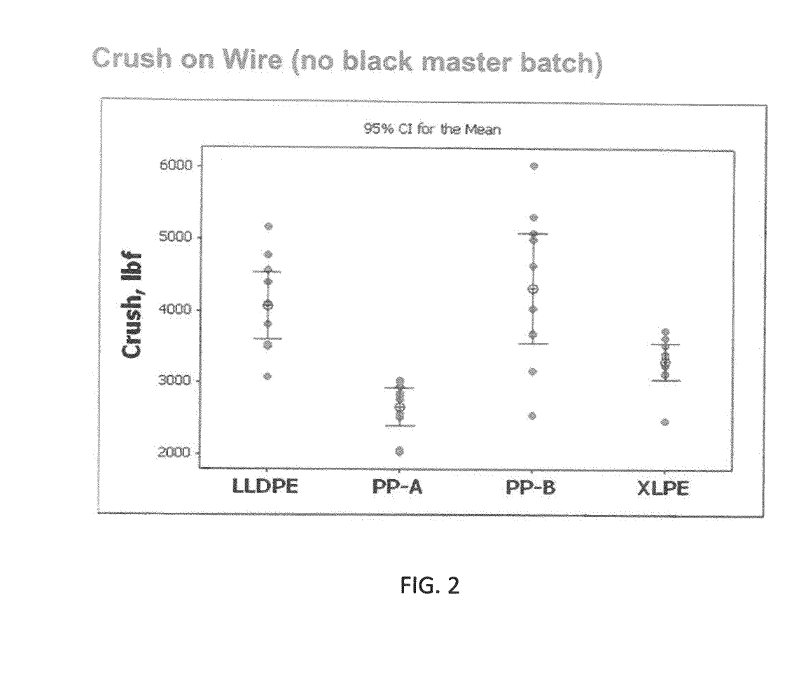

FIG. 3 shows the toughness of impact modified polypropylenes;

FIG. 4 shows the tailoring rubber content and structure to meet performance;

FIG. 5 shows the increasing rubber content lowers PP modulus;

FIG. 6 shows the coefficient of friction which was measured against HDPE extruded tape with no lubricant;

FIG. 7 shows the comparison to jacket performance requirements;

FIG. 8 shows a graph of the tensile properties;

FIG. 9 shows a graph of the elongation properties;

FIG. 10 shows a graph comparing the 1″ melt peak, 2″ melt peak and enthalpy of various samples;

FIG. 11 shows a graph comparing the flex modulus of various samples;

FIG. 12 shows a graph comparing the heat distortion of various samples;

FIG. 13 shows a graph comparing the vicat softening temperature of various samples;

FIG. 14 shows a graph comparing the gardner puncture of various samples;

FIG. 15 shows a graph comparing the dynatup at −40C of various samples;

FIG. 16 shows a graph comparing the coefficient of friction of various samples;

FIG. 17 shows a graph of the storage modulus versus temperature;

FIG. 18 shows a graph of the storage modulus versus temperature;

FIG. 19 shows a graph of the loss modulus versus temperature;

FIG. 20 shows a graph of the loss modulus versus temperature;

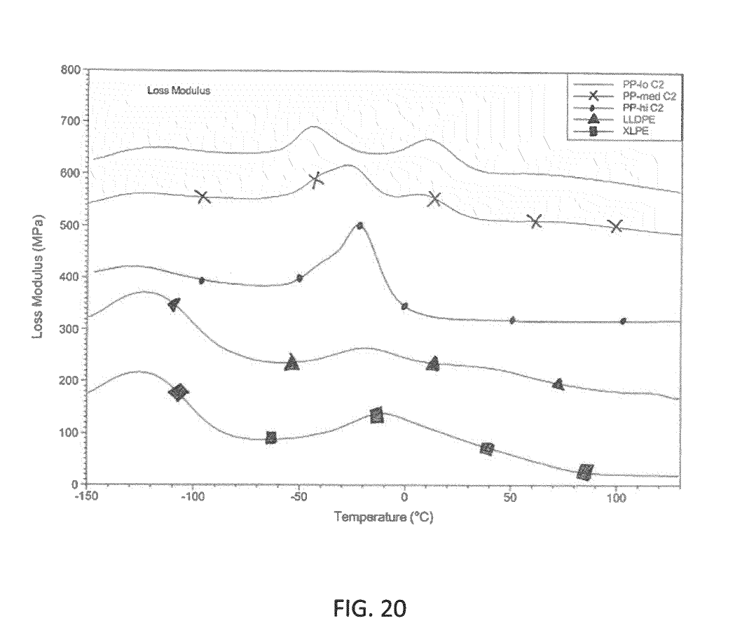

FIG. 21 shows a graph of the Tan Delta versus temperature;

FIG. 22 shows a graph of the Tan Delta versus temperature; and,

FIG. 23 shows a graph of the heat flow (W/g) for various samples.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Linear low density polyethylene has been the primary jacketing resin for medium voltage cable in the North American region in recent times. In 25 other regions, such as in Europe, the focus has largely been on medium density polyethylene and high density polyethylene jacketing for medium voltage applications. It is believed that polypropylene based jacketing is a viable option for use in medium voltage cables.

Prior to the 1980's, underground medium voltage power cables 30 were jacketed with materials such as poly vinyl chloride in order to reduce neutral corrosion and improve the life of the power cables. In the 1980's, low density polyethylene jackets were introduced. Since that time, low density polyethylene (LDPE), including linear low polyethylene (LLDPE), has been commonly used as a jacketing resin for medium voltage cables. This is particularly true in the North American regions. In other regions, such as in Europe, the focus has largely been on medium density polyethylene and high density polyethylene jacketing for medium voltage applications.

In the early 1990's, polypropylene jacketing was used for ethylene 5 propylene rubber (EPR) insulated medium voltage power cable applications. This jacketing was used primarily in power cables for urban systems with restrictions associated with ducted systems. The present invention relates to the use of polypropylene jacketing for cross-linked polyethylene insulated medium voltage power cable applications.

Higher thermal rated (HTR) jackets have certain benefits, such as cooler operation, lower line loss, and improved thermo-mechanical properties. Additionally, HTR jackets may be less expensive due to reduced need for copper. HTR jackets also provide an ability to reduce the wall thickness of the cable design. Polypropylene also presents certain advantages for use in cables. For instance, 15 polypropylene is recyclable, and it is unlimited by the curing process. Polypropylene does not require pre-drying or any special extruder configurations. Additionally, polypropylene is not impacted by ambient humidity.

Polypropylene is a valid alternative for HTR jacket designs. Polypropylene provides good high temperature performance and can also be 20 optimized for low temperature performance on cable. Additionally, the range of polypropylene resins can provide a broad array of various design options. For instance, high crystallinity polypropylene homopolymers can provide good strength to weight ratios, are resistant to many corrosive chemicals and also endure abrasive treatment. Polypropylene copolymers offer flexibility and also low 25 temperature and impact performance.

Additionally, rubber modified polypropylene may improve certain properties of polypropylene, including properties such as flexibility and low temperature properties. The level, type, and dispersion of rubber component in polypropylene copolymers results in various stiffness and strength parameters and 30 also impacts the low temperature performance of the polypropylene.

It should be understood that various additives can be included in the polypropylene resin compositions, including antioxidants, colorants, and other additives know to those of skill in the art.

In the most preferred embodiments, the polypropylene jackets will 5 meet the following specifications: a tensile strength of greater than or equal to 1500 psi (or greater than or equal to 10.3 MPa); and elongation at break of 150% or greater. Additionally, the aged requirements (121° C. for 168 hours) in most preferred embodiments are a retained tensile strength that is 70% of the original, and a retained elongation that is 70% of the original. Additionally, in most 10 preferred embodiments, the heat distortion at 131° C. is less than or equal to 30%. Additionally, in most preferred embodiments then carbon black percentage is 2% or greater. It should be understood, that in other embodiments of the polypropylene jackets, the various specifications and or requirements may fall outside some or all of these ranges.

To facilitate a better understanding of the present invention, the following examples are given. In no way should the following examples be read to limit, or to define, the scope of the invention.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

In Example 1, four resins were selected for comparison in HTR jacket materials.

| Resin | Material | Additives |
|---|---|---|
| 1 | Linear low density | Typical antioxidant |
| | polyethylene | packages for air oven |
| | | aging studies |
| 2 | Impact Modified PP-A | Typical antioxidant |
| | | packages for air oven |
| | | aging studies |
| 3 | Impact Modified PP-B | Typical antioxidant |
| | | packages for air oven |
| | | aging studies |
| 4 | Moisture Cure Cross- | Typical antioxidant |
| | linked Polyethylene | packages for air oven |
| | | aging studies |

The four resins were tested.

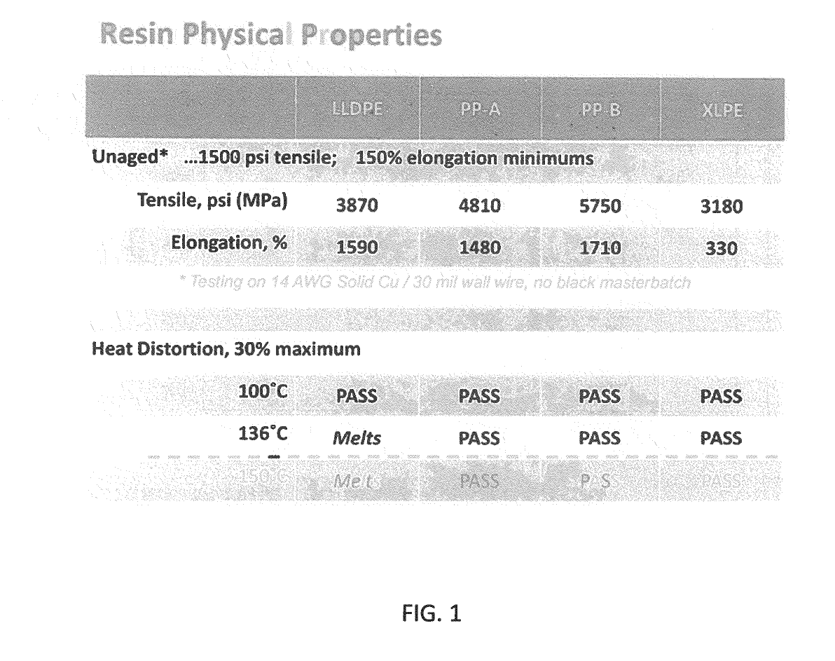

The resin physical properties are described in FIG. 1.

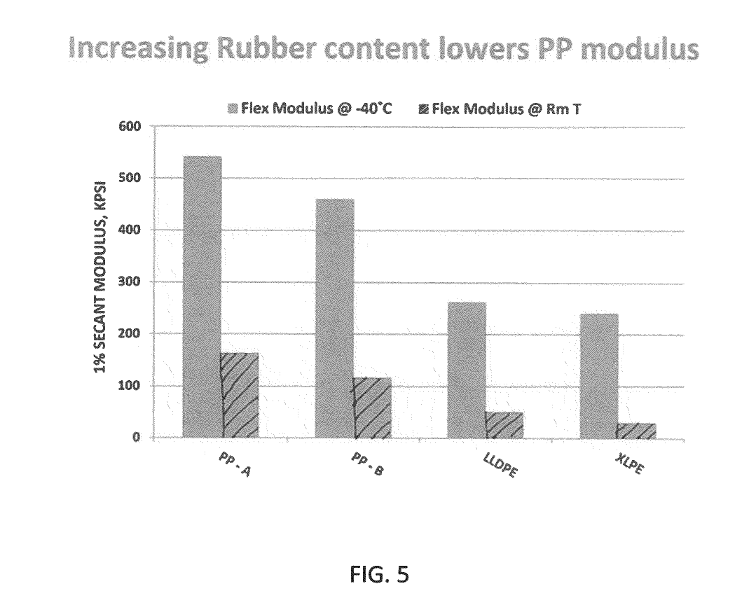

The results of crush tests for the four resins are described in FIG. 5 2.

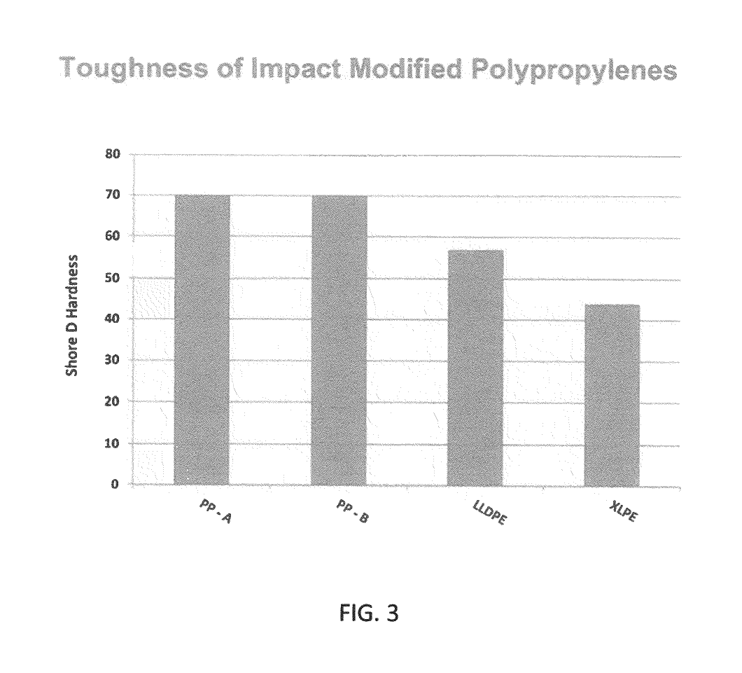

The results of Shore D Hardness tests are described in FIG. 3.

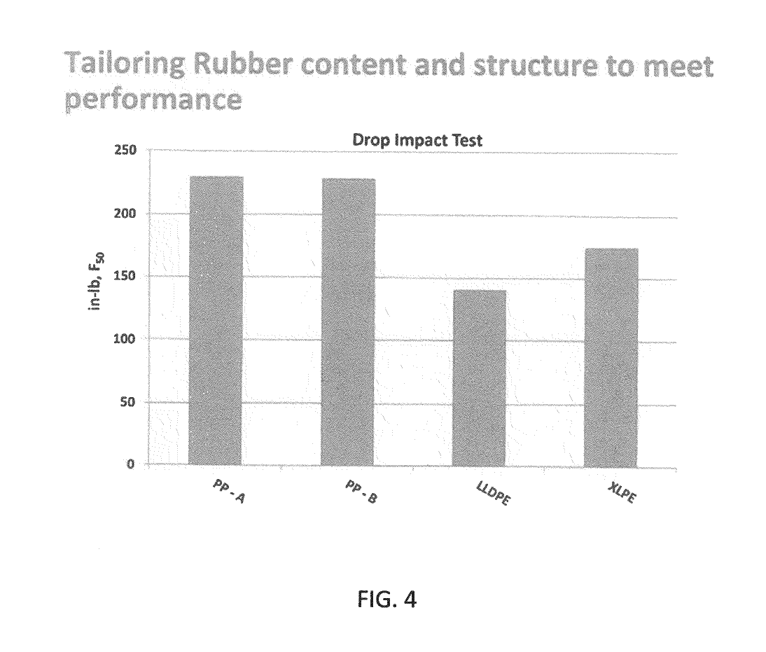

The results of Drop Impact tests are described in FIG. 4.

The results of flex modulus tests are described in FIG. 5.

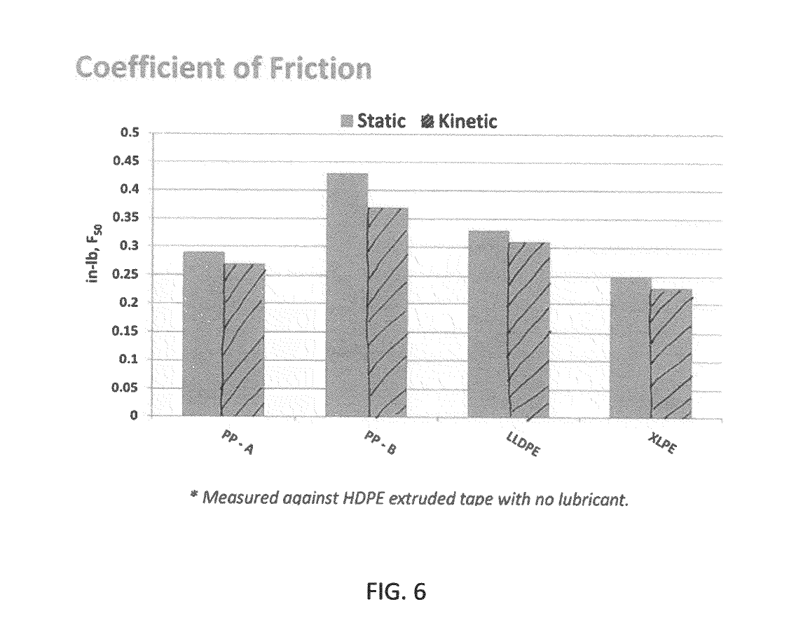

The results of coefficient of friction tests are described in FIG. 6.

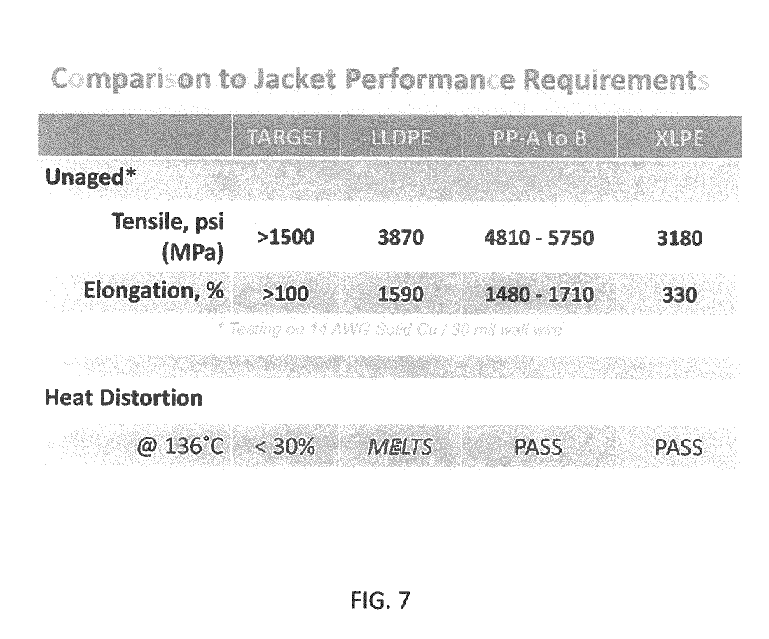

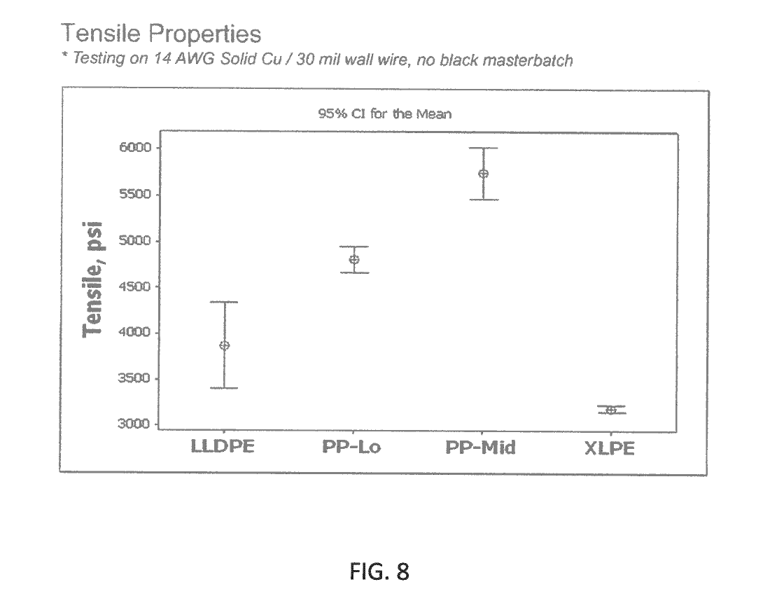

The tensile properties of the test wires are described in FIGS. 7 and 8.

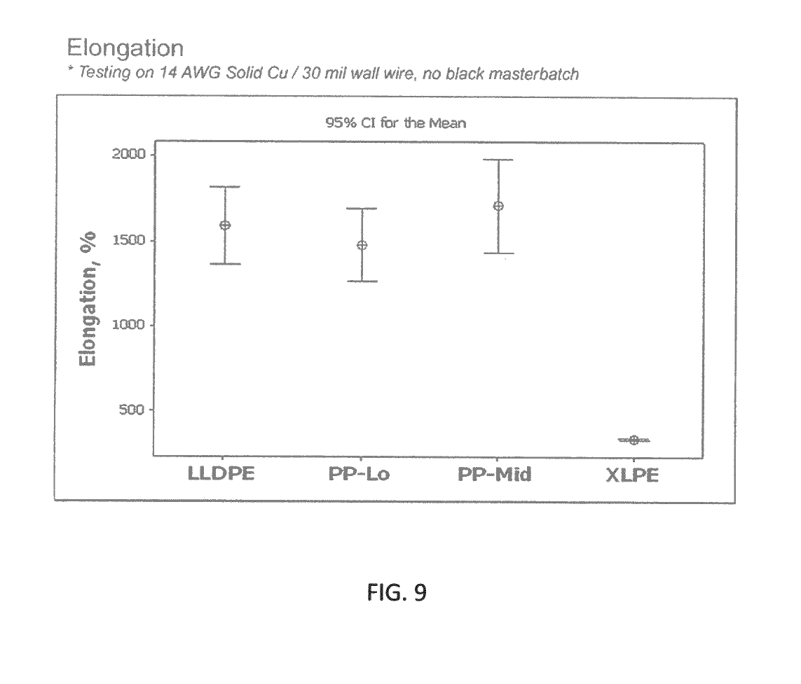

The elongation properties of the test wires are described in FIGS. 7 and 9.

As seen in FIG. 7, the polypropylene compositions exceeded the 15 target for tensile strength and elongation at break. Additionally, the polypropylene compositions passed the heat distortion test as shown in FIG. 7.

### Example 2

In Example 2, seven resins were selected for comparison in HTR jacket materials.

| Resin | Material |
|---|---|
| 1 | Pro-fax HP403G - Homo polypropylene |
| 2 | PP1510PC - PP Lo |
| 3 | Hifax X 1956 A - PP-Mid |
| 4 | Hifax C10A - PP-Hi |
| 5 | PETROTHENE GA 808-091 - LLDPE |
| 6 | Spherilene hexane bimodal HDPE |
| 7 | AQ120 + 5% CM04483 - XLPE |

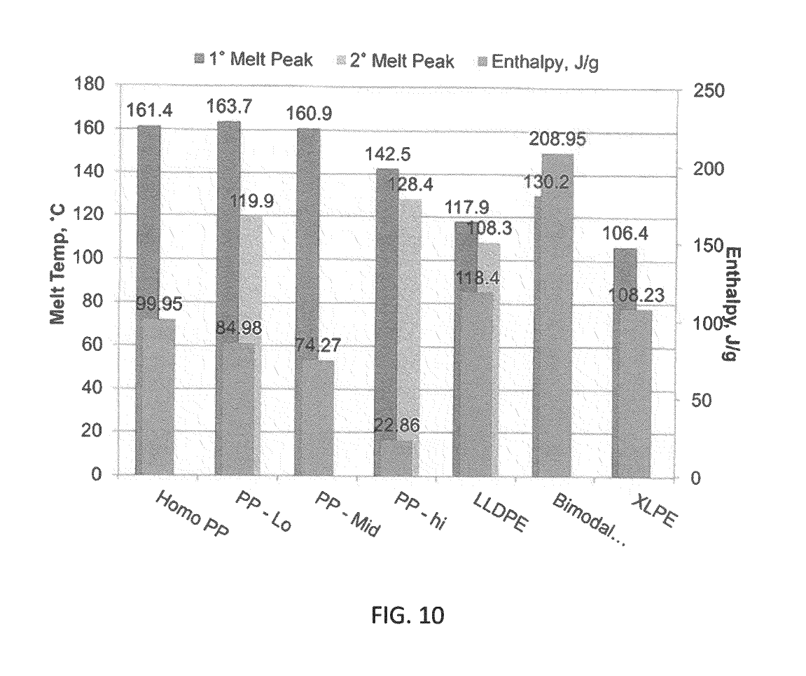

The melt properties of the resins are described in FIG. 10. Please note that the XLPE does not actually melt as it is cross-linked, thus this data point is not reflective of melting point.

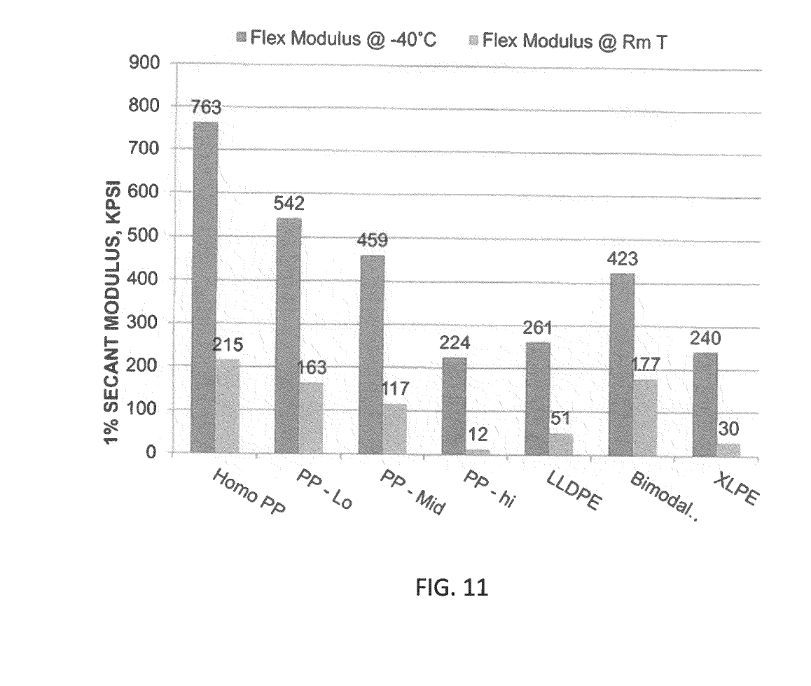

The results of flex modulus tests are described in FIG. 11.

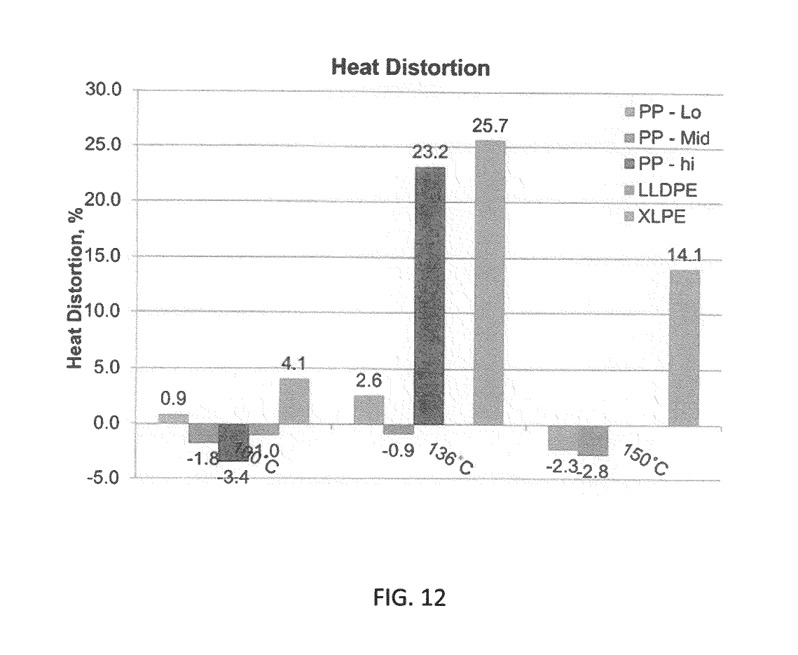

The results of heat distortion tests are described in FIG. 12.

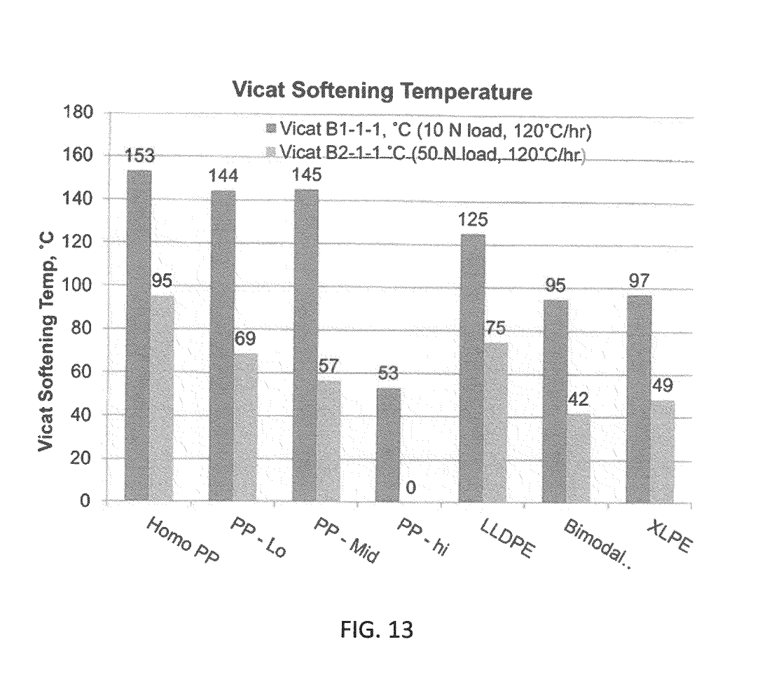

The results of vicat softening temperature tests are described in FIG. 13. Please note that the XLPE does not actually melt as it is cross-linked, thus this data point is not reflective of melting point.

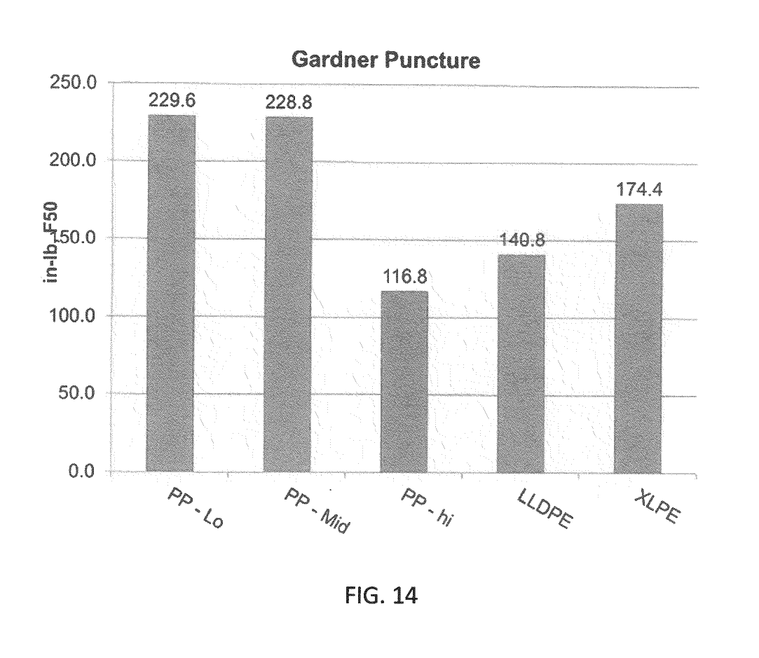

The results of Garner Puncture tests are described in FIG. 14.

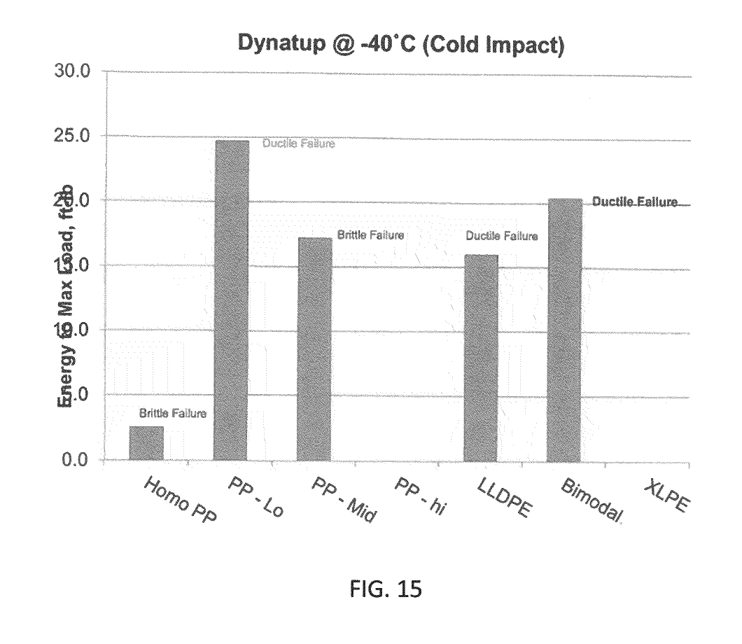

The results of impact tests are described in FIG. 15.

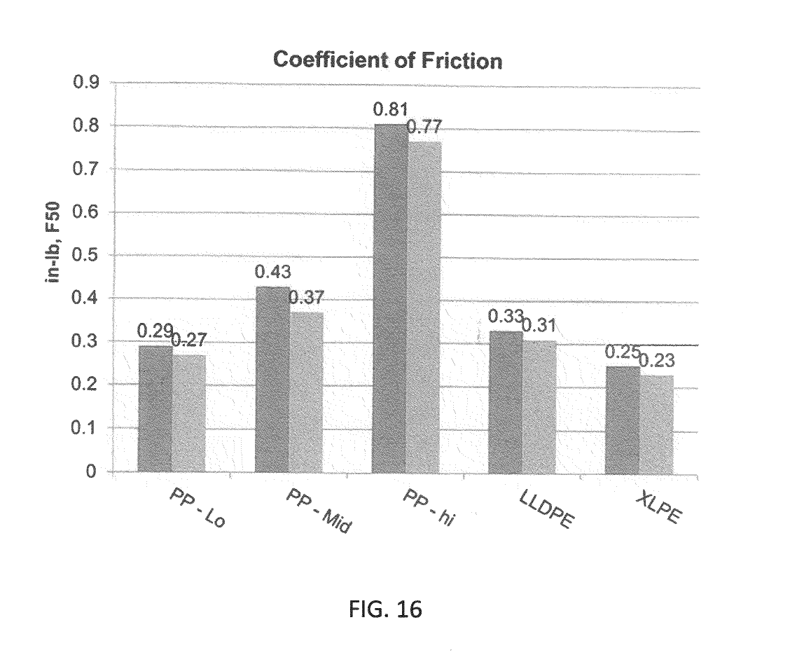

The results of coefficient of friction tests are described in FIG. 16.

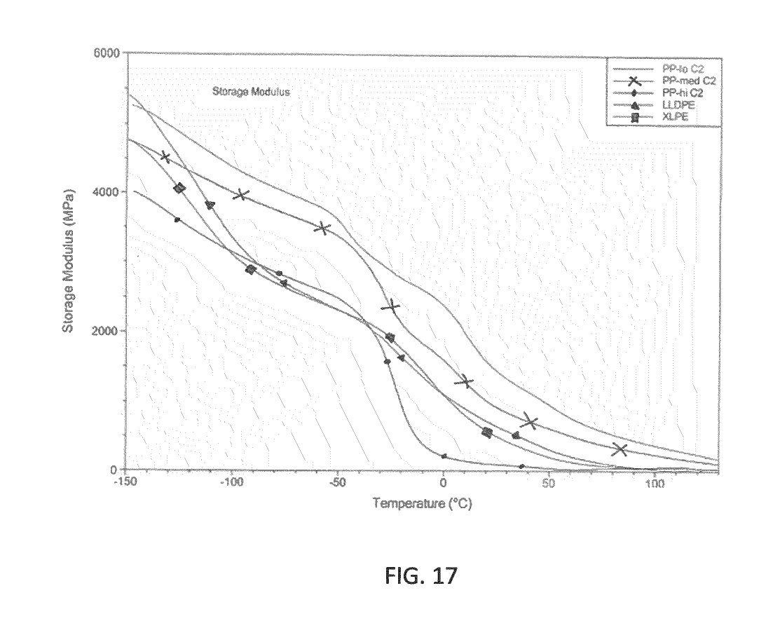

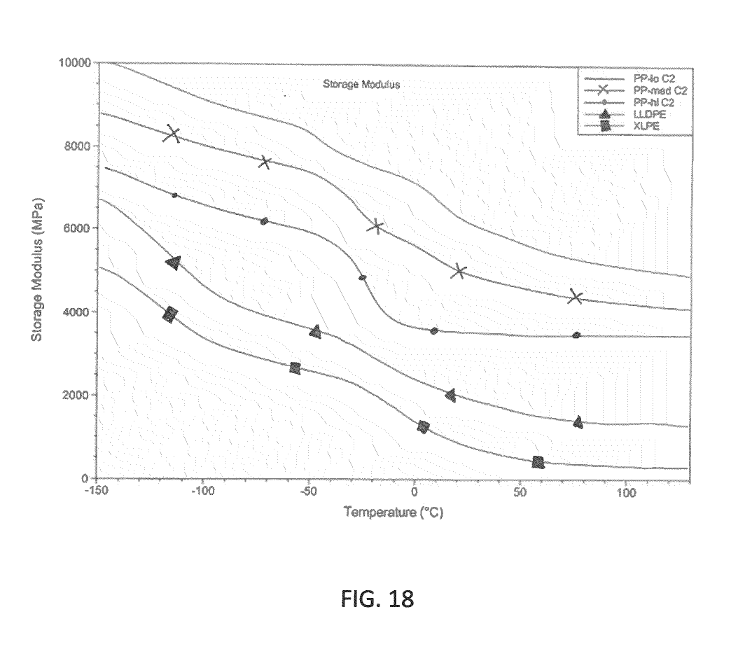

The results of storage modulus tests are described in FIGS. 17 and 18.

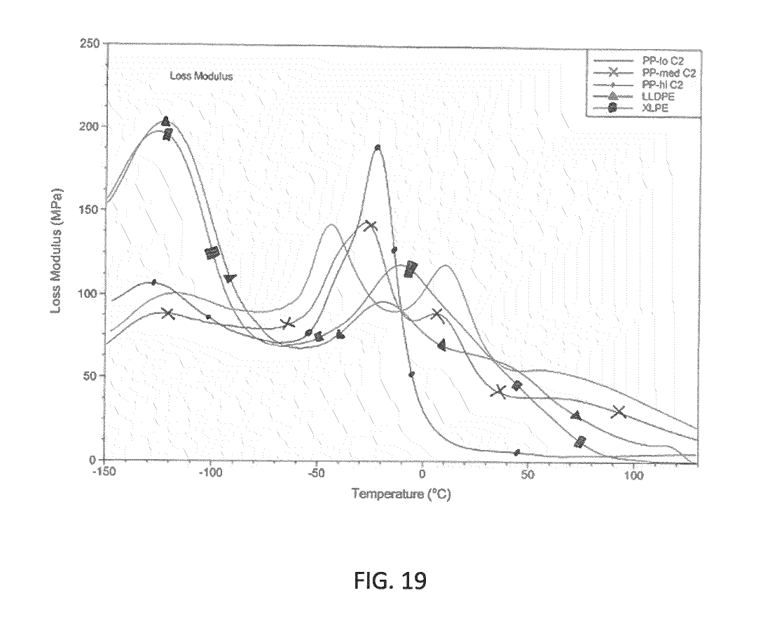

The results of loss modulus tests are described in FIGS. 19 and 15 20.

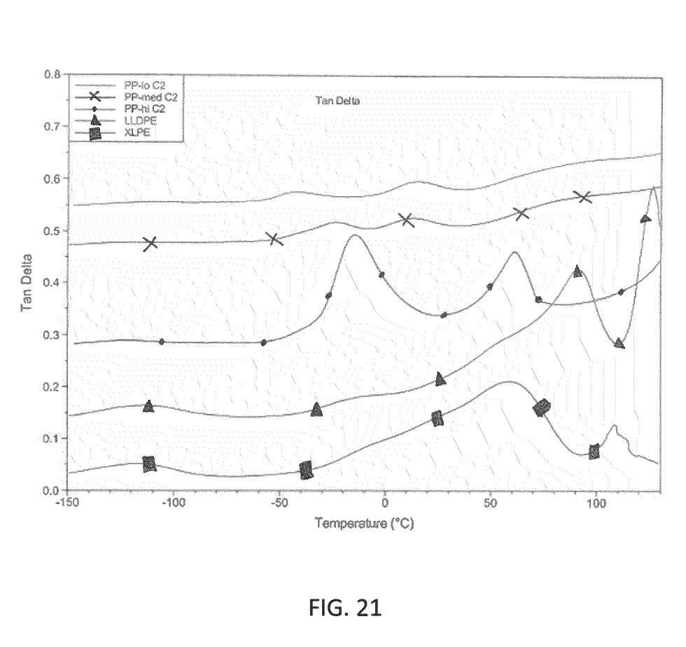

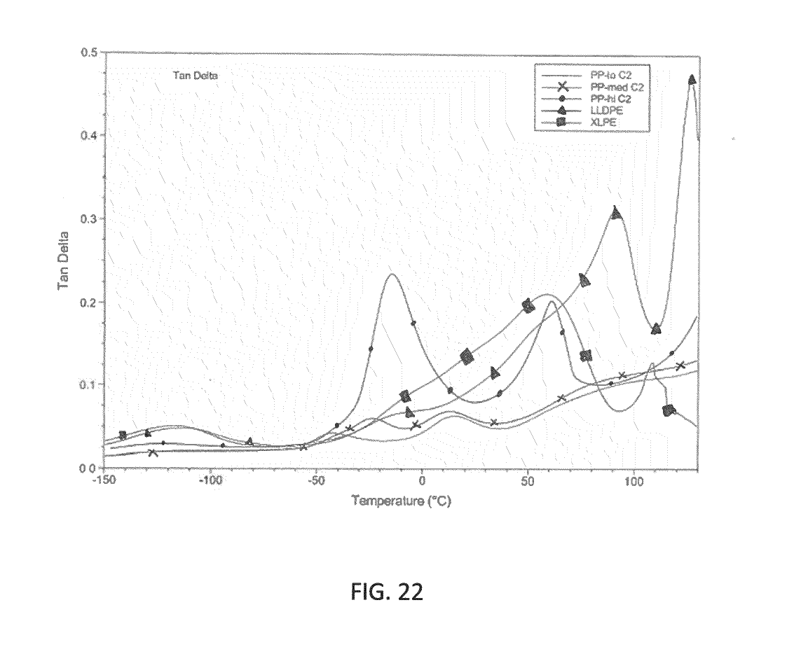

The dissipation factor testing is described in FIGS. 21 and 22.

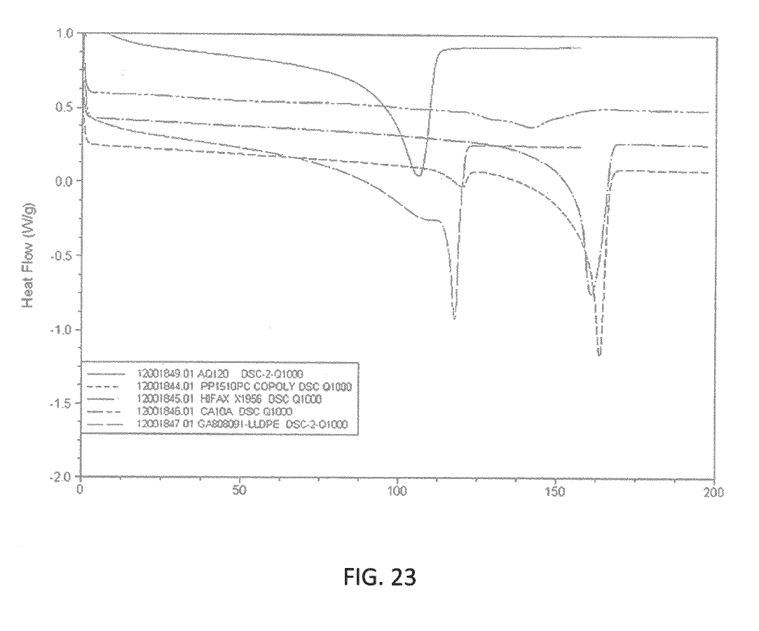

The heat flow data is shown in FIG. 23.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite particles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A polypropylene jackets having
a tensile strength of greater than or equal to 1500 psi (or greater than or equal to 10.3 MPa); and, elongation at break of 150% or greater.
